(19) United States
(12) Patent Application Publication
(10) Pub. No.: US 2021/0405627 A1
(43) Pub. Date: Dec. 30, 2021

(54) PRODUCTION PLANNING SYSTEM

(71) Applicant: HITACHI, LTD., Tokyo (JP)

(72) Inventors: Yuma SHIHO, Tokyo (JP); Masataka TANAKA, Tokyo (JP); Hiroyuki SEYA, Tokyo (JP)

(21) Appl. No.: 17/348,807

(22) Filed: Jun. 16, 2021

(30) Foreign Application Priority Data
Jun. 25, 2020 (JP) 2020-109318

(51) Int. Cl. G05B 19/418

(52) U.S. Cl. CPC G05B 19/4188; G05B 19/41865; G05B 19/41885

(57) ABSTRACT

A production planning system includes: an influence degree calculation unit that calculates a degree of influence which is applied on a probability distribution of a workload in a predetermined production process of a product by determining an undetermined design specification item of the product; and a display control unit that causes the design specification item and the degree of influence to be displayed in association with each other.

### CROSS-REFERENCE TO RELATED APPLICATION

The present application claims priority from Japanese application JP2020-109318, filed on Jun. 25, 2021, the contents of which is hereby incorporated by reference into this application.

### BACKGROUND

### Technical Field

The present invention relates to a production planning system.

### Related Art

JP 2015-148961 A discloses a standard working time estimation device which includes: a working type classification unit that classifies working time data for each working type item value included in working time history data and generates working time history data; a representative reference time calculation unit that calculates a representative reference time for each working type item value from the working time history data; an attribute item classification unit that classifies the working time history data for each attribute item value and generates working time history data; a subdivided reference time calculation unit that calculates a subdivided reference time for each attribute item value from the working time history data; and a significance evaluation unit that sets the subdivided reference time determined to have significance as a reference time of the relevant attribute item value and, for attribute item values other than that, sets the representative reference time as the reference time.

### PATENT LITERATURE

PTL 1: JP 2015-148961 A

### SUMMARY OF INVENTION

### Technical Problem

In JP 2015-148961 A described above, a working time is estimated with work items subdivided. However, in manufacturing work of an individually-ordered design product such as a control panel, in many cases, specifications are determined stepwise while a design, such as which units to use, which and how many components to use, and which structure to build, progresses, and a prediction accuracy of working time (workload) also varies with the progress of specification determination. However, it is difficult to determine the design specification item to be preferentially determined for efficiency.

An object of the present invention is to provide a technique for presenting a design specification item effective for improving a prediction accuracy of a workload.

### Solution to Problem

The present application includes a plurality of means for solving at least a part of the above problems, and examples thereof are as follows.

According to one aspect of the present invention, a production planning system includes: an influence degree calculation unit that calculates a degree of influence which is applied on a probability distribution of a workload in a predetermined production process of a product by determining an undetermined design specification item of the product; and a display control unit that causes the design specification item and the degree of influence to be displayed in association with each other.

### Advantageous Effect of Invention

According to the present invention, it is possible to present the design specification item effective for improving the prediction accuracy of the workload.

Problems, configurations, and effects other than those described above will be clarified by the following description of embodiments.

### BRIEF DESCRIPTION OF DRAWINGS

FIG. 1 is a diagram illustrating a configuration example of a production planning system according to a first embodiment;

FIG. 2 is a diagram illustrating an example of a data structure of production plan information;

FIG. 3 is a diagram illustrating an example of a data structure of total workload distribution information;

FIG. 4 is a diagram illustrating an example of a data structure of violation probability information;

FIG. 5 is a diagram illustrating an example of a data structure of influence degree information;

FIG. 6 is a diagram illustrating an example of a data structure of a design specification master;

FIG. 7 is a diagram illustrating an example of a hardware configuration of a production planning system;

FIG. 8 is a diagram illustrating an example of a flow of design assistance processing; and

FIG. 9 is a diagram illustrating an example of a workload analysis screen.

### DESCRIPTION OF EMBODIMENTS

In the following embodiment, when necessary for the sake of convenience, the description will be divided into a plurality of sections or embodiments, but unless otherwise specified, the sections or embodiments are not unrelated to each other, and one is in a relationship of some or all modifications, details, supplementary explanation, and the like of the other.

In addition, in the following embodiments, when referring to the number of elements or the like (including number, numerical value, amount, range, and the like), the number is not limited to a specific number unless otherwise specified or obviously limited to the specific number in principle, and the number may be greater than or equal to the specific number or may be less than or equal to the specific number.

Furthermore, in the following embodiments, it is needless to say that the components (including element steps and the like) are not necessarily essential unless otherwise specified or considered to be obviously essential in principle.

Similarly, in the following embodiments, when the shapes, positional relationships, and the like of the components and the like are referred to, unless otherwise specified or considered to be obviously not in principle, the shapes and the like substantially approximate or similar to the shapes and the like are included. The same applies to the above numerical values and ranges.

In all the drawings for describing the embodiments, the same members are denoted by the same reference numerals in principle, and description thereof will not be repeated. Hereinafter, each embodiment of the present invention will be described with reference to the drawings.

Conventionally, in a factory that produces an industrial product, a production plan is often prepared by gradually changing a scope period from a long period to a short period. For example, a major schedule and a minor schedule in which any of predetermined periods such as a year unit, a quarter unit, a month unit, a week unit, a day unit, and a time unit is set as a scope are often planned.

In such a production plan preparing method, in general, detailed constraint information (including design information) which is not known at the time of preparing the major schedule is added, and thus, a plan with higher accuracy can be calculated at time of the minor schedule. However, in a case where the constraint information of the work capacity (the amount of work to be performed within a predetermined period), the workload (which means the work amount required to complete the work and can be quantified, for example, as a working time or the like for executing out a certain process of manufacturing a certain product), and the like is not added, the accuracy of the minor schedule is bound to be low. For example, in a case where a design specification item necessary for producing a certain product is undetermined, a specific workload cannot be specified without waiting for determination of the design content, and the manufacturing amount of other products, the assignment amount of workers, the delivery date, and the like cannot be specifically planned. That is, it is necessary to prepare a minor schedule having a high risk of variation.

Even when products are divided for each production process, and a schedule for executing a process is determined, the accuracy improvement of the production plan is inefficient if a factor varying in constraint information remains large. For example, in a case where the industrial product to be produced is an individually-ordered design product, design is often advanced as specifications are selected as needed, and roughly, the number of the variable elements decreases according to the design progress, and the prediction accuracy of the workload increases. Therefore, at the initial stage of design with many undetermined specifications, it is not easy to prepare a production plan based on highly accurate prediction of a workload.

Under such circumstances, in order to perform design with less variable elements of constraint information, a method is considered which evaluates a workload and a degree of variation thereof within a range of determined design specifications, extracts a product with a large variation, evaluates a degree of decrease in the variation of the workload at the time of determining each design specification item for the product, and preferentially determines a design specification item with a large degree of decrease.

There is also a limit to the products that can be designed at one time. In a production planning system according to the present invention, a specification to be preferentially designed can be selected by specifying a date on which variation in workload becomes a constraint violation and clarifying a design specification item that greatly affects the workload on the date. Therefore, the accuracy of the production plan can be improved more efficiently. Incidentally, since the workload includes a variable element at the time of production planning, it is preferable that the workload is shown with a standard value such as an average value or a probability distribution (which may be either a normal distribution or a probability distribution other than the normal distribution). For example, the probability distribution of the workload of a product X1 and a process P1 can be shown as following normal distribution N(5,2). Incidentally, N(5,2) represents a normal distribution with an average of 5 and a variance of 2. Similarly, a total workload which is the sum of the workloads can also be shown as a probability distribution.

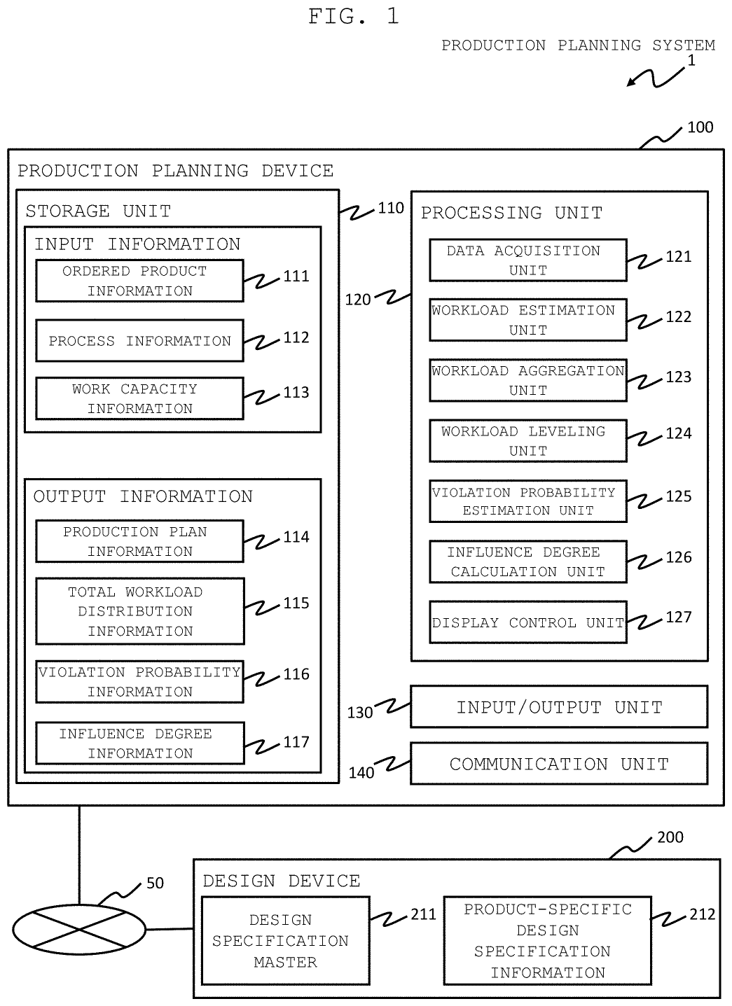

FIG. 1 is a diagram illustrating a configuration example of a production planning system according to a first embodiment. A production planning system 1 according to the present invention includes a production planning device 100 and a designing device 200 communicably connected to the production planning device 100 via a network 50.

The network 50 is, for example, any one or a combination of a local area network (LAN), a wide area network (WAN), a virtual private network (VPN), a communication network using a general public line such as the Internet in part or in whole, a mobile phone communication network, and the like. Incidentally, the network 50 may be a wireless communication network such as Wi-Fi (registered trademark) or 5G (Generation).

The production planning device 100 is an information processing device including a storage unit 110, a processing unit 120, an input/output unit 130, and a communication unit 140. The storage unit 110 roughly stores input information and output information. The input information includes ordered product information 111, process information 112, and work capacity information 113. The output information includes production plan information 114, total workload distribution information 115, violation probability information 116, and influence degree information 117.

The ordered product information 111 is information for specifying a product targeted for order production. The process information 112 is information on a series of processes executed when the product specified by the ordered product information 111 is produced. The work capacity information 113 is information for specifying work capacity that can be assigned in a predetermined period, for example, man-hours or working hours. These pieces of input information may be stored in advance in the storage unit 110, or may be input through the input/output unit 130.

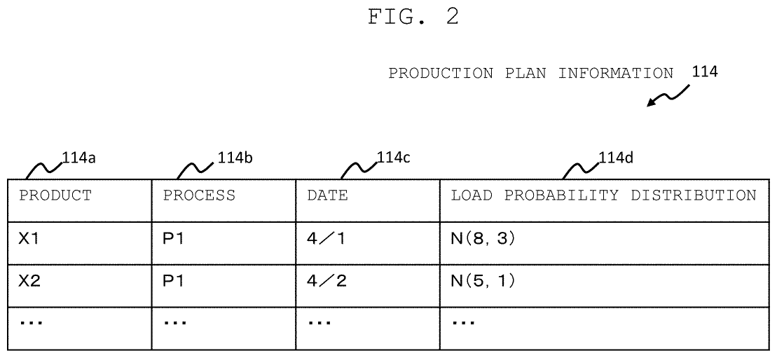

FIG. 2 is a diagram illustrating an example of a data structure of production plan information. The production plan information 114 is information in which a product 114a, a process 114b, a date 114c, and a load probability distribution 114d are associated with each other.

The product 114a is information for specifying a product to be manufactured, the process 114b is information for specifying a process to be executed, and the date 114c is information for specifying a date for executing the process specified by the process 114b.

The load probability distribution 114d indicates, with a probability distribution, the workload at the time of producing the process specified by the process 114b of the product specified by the product 114a on the date specified by the date 114c. That is, the workload is treated as a probability distribution and is an uncertain value.

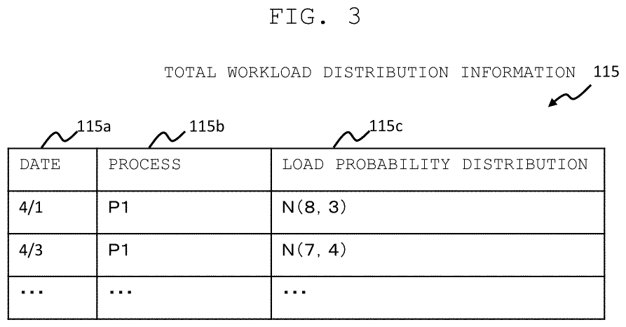

FIG. 3 is a diagram illustrating an example of a data structure of total workload distribution information. The total workload distribution information 115 is information for specifying a set of works, for example, a distribution of total workloads on a certain date in process units. The total workload distribution information 115 is information in which a date 115a, a process 115b, and a load probability distribution 115c are associated with each other.

The date 115a is information for specifying a date. The process 115b is information for specifying a process to be executed. The load probability distribution 115c is information indicating a probability distribution of a sum of workloads for executing the same process on the same date.

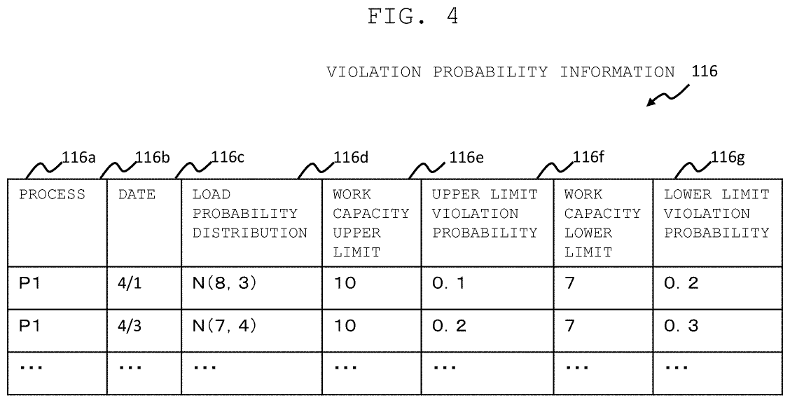

FIG. 4 is a diagram illustrating an example of a data structure of violation probability information. The violation probability information 116 is information for specifying a probability of exceeding the upper limit of the work capacity and a probability of falling below the lower limit of the work capacity, that is, a probability of violating the constraint of the work capacity. The violation probability information 116 is information in which a process 116a, a date 116b, a load probability distribution 116c, a work capacity upper limit 116d, an upper limit violation probability 116e, a work capacity lower limit 116f, and a lower limit violation probability 116g are associated with each other.

The process 116a is information for specifying a work process. The date 116b is information for specifying a date. The load probability distribution 116c is information indicating a probability distribution of a sum of workloads for executing the same process on the same date.

The work capacity upper limit 116d is information for specifying an upper limit of work capacity for executing the same process on the same date. The upper limit violation probability 116e is information for specifying a probability that the workload exceeds the upper limit of the work capacity specified by the work capacity upper limit 116d. The work capacity lower limit 116f is information for specifying a lower limit of the work capacity for executing the same process on the same date. The lower limit violation probability 116g is information for specifying a probability that the workload falls below the lower limit of the work capacity specified by the work capacity lower limit 116f.

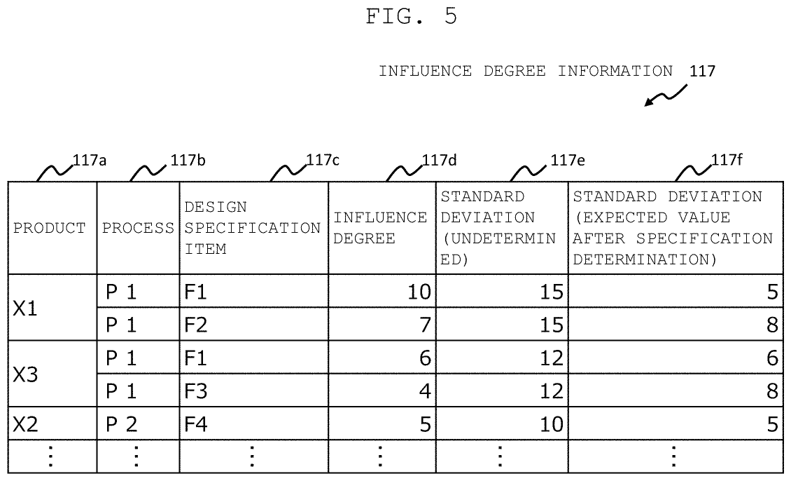

FIG. 5 is a diagram illustrating an example of a data structure of influence degree information. The influence degree information 117 is information in which the degree of the influence of the determination of the specification on the workload is associated with for each design specification item. For example, it is information in which a degree (degree of influence) of decreasing the standard deviation of the workload is set to “7” to be associated with a design specification item “F2” of a product “X1”.

The influence degree information 117 includes a product 117a, a process 117b, a design specification item 117c, an influence degree 117d, a standard deviation (undetermined) 117e, and a standard deviation (expected value after specification determination) 117f. The product 117a is information for specifying a product, and the process 117b is information for specifying a process to be designed. Further, the design specification item 117c is information for specifying an item of a specification to be designed. The influence degree 117d is information indicating the degree of decrease in the standard deviation of the workload when the specification specified by the design specification item 117c in the product specified by the product 117a is determined.

The standard deviation (undetermined) 117e is information for specifying the standard deviation of the workload before the determination of the specification specified by the design specification item 117c in the process 117b of the product specified by the product 117a. The standard deviation (expected value after specification determination) 117f is information for specifying an expected value of the standard deviation of the workload after the determination of the specification specified by the design specification item 117c in the process 117b of the product specified by the product 117a.

The processing unit 120 includes a data acquisition unit 121, a workload estimation unit 122, a workload aggregation unit 123, a workload leveling unit 124, a violation probability estimation unit 125, an influence degree calculation unit 126, and a display control unit 127.

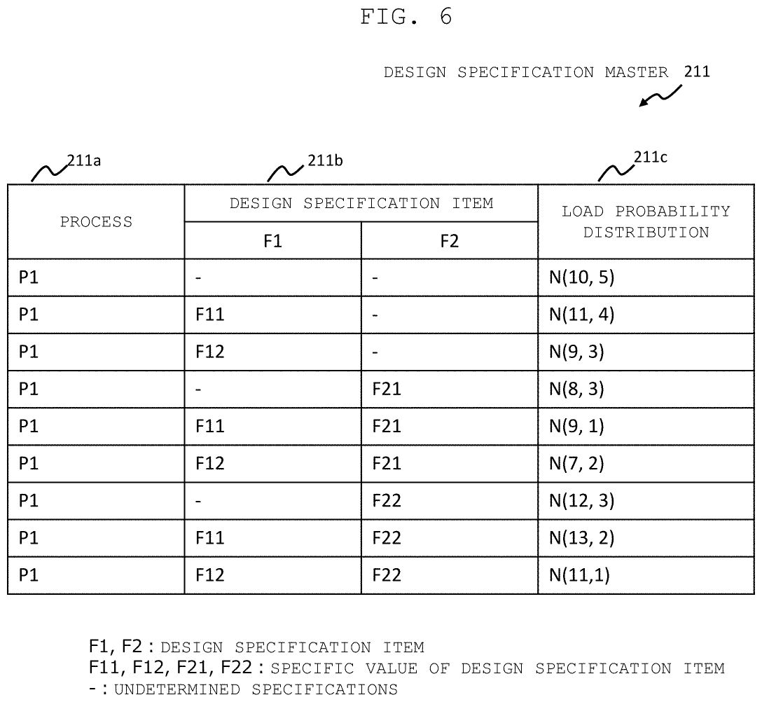

The data acquisition unit 121 reads data from the input information of the storage unit 110. The workload estimation unit 122 estimates a probability distribution of a workload on a product-individual basis according to a design item of which the specification is determined for each combination of products and execution processes. The workload aggregation unit 123 aggregates the total workload distribution information 115 for each predetermined work unit (for example, process and date). Specifically, the workload aggregation unit 123 aggregates the probability distribution of the total workload by the sum of the workloads of all products produced for each date and process. Incidentally, the workload estimation unit 122 estimates the probability distribution of the workload by reading the load probability distribution for each process and design specification item included in a design specification master 211. For example, in the case of using the design specification master 211 illustrated in FIG. 6, when, for the process P1, the value of the design specification item F1 for the target product is “F11”, and the value of F2 is undetermined, the workload estimation unit 122 obtains that the load probability distribution is N(11,4) and estimates the probability distribution of the workload.

The workload leveling unit 124 levels the workload by flattening. Specifically, the workload leveling unit 124 specifies a date on which the total workload for each date and process aggregated by the workload aggregation unit 123 is an expected value equal to or greater than a predetermined value, and performs adjustment processing such as advancing or delaying the work to be executed on the specified date by using an existing algorithm (for example, a process of using the standard value (for example, the average value) of the total workload and advancing the work in which the standard value exceeds the reference value of the work capacity). As a result, the peak of the workload can be suppressed to be low.

The violation probability estimation unit 125 estimates a probability that the total workload for each date and process violates the constraint of the work capacity. Specifically, the violation probability estimation unit 125 estimates, for the work plan leveled by the workload leveling unit 124, the probability distribution of the total workload which is the sum of the workloads of all products to be produced according to a design item with determined specifications for each combination of dates and execution processes. Then, the violation probability estimation unit 125 estimates the upper/lower limit constraint violation probability of the total workload.

Specifically, the violation probability estimation unit 125 estimates a probability that the total workload exceeds upper and lower limit values (a violation probability which is a probability of not being included in the work capacity) in a range specified by the upper limit value and the lower limit value of the work amount indicating the work capacity of each date and process set as the work capacity information 113. For example, assuming that the upper limit of the work capacity is ten hours, and the lower limit is seven hours, the violation probability estimation unit 125 calculates a probability that the workload according to N(8,3) exceeds ten hours and a probability that the workload is less than seven hours.

The influence degree calculation unit 126 calculates the degree of influence which is applied on the probability distribution of the workload by determining the design specification item for the product for which the date when the upper/lower limit constraint violation probability becomes equal to or greater than a predetermined threshold is the execution date of the process, and calculates the design specification item of the product as a candidate for preferentially designing.

Specifically, the influence degree calculation unit 126 specifies, as a candidate, the date and the process in which the upper/lower limit constraint violation probability is equal to or greater than the predetermined threshold. Then, the influence degree calculation unit 126 selects a product having a large variation in workload as a candidate to be preferentially designed among the products which are produced on the specified date and process. Then, the influence degree calculation unit 126 calculates the influence degree to be the expected value of the variation reduction amount of the workload at the time of determination for each design specification of the target product.

The influence degree calculation unit 126 calculates the influence degree according to a predetermined algorithm using past performances. Incidentally, the influence degree calculation unit 126 may calculate a change amount of the violation probability as the influence degree.

The display control unit 127 extracts a design specification item having a large variation reduction amount (influence degree) of the workload from the target product, and creates and outputs screen information for displaying the design specification item and the influence degree in association with each other. Alternatively, the display control unit 127 may extract, from the target product, a design specification item in which the workload increases when the variation reduction amount (influence degree) of the workload is applied, that is, a design specification item having the smallest standard deviation (expected value after specification determination) 117f, and create and output the screen information displaying the design specification item and the influence degree in association with each other.

The display control unit 127 creates and outputs screen information for displaying a predetermined process, an execution date, and a violation probability in association with each other. In addition, the display control unit 127 creates and outputs screen information for displaying a graph showing the probability distribution of the violation probability for each execution date. In addition, the display control unit 127 causes the design specification item in which the probability distribution further converges due to determination of the design specification item to be displayed as a prioritized design item.

For example, the input/output unit 130 displays screen information including information for outputting a result of performing predetermined processing and receives the input information input by a keyboard, a mouse, a touch panel, or the like.

The communication unit 140 transmits and receives information to and from other devices including the designing device 200 via the network 50.

The designing device 200 is an information processing device which executes a process of designing a product. The designing device 200 includes a storage unit which holds the design specification master 211 and product-specific design specification information 212 as data. The design specification master 211 stores information on the probability distribution of the workload based on performances for each design specification item. The product-specific design specification information 212 stores information (individual design information) on the design specification item of a product to be produced.

FIG. 6 is a diagram illustrating an example of a data structure of a design specification master. The design specification master 211 is information in which the load probability distribution is specified according to the design specification for each process. Specifically, the design specification master 211 includes a process 211a, a design specification item 211b, and a load probability distribution 211c.

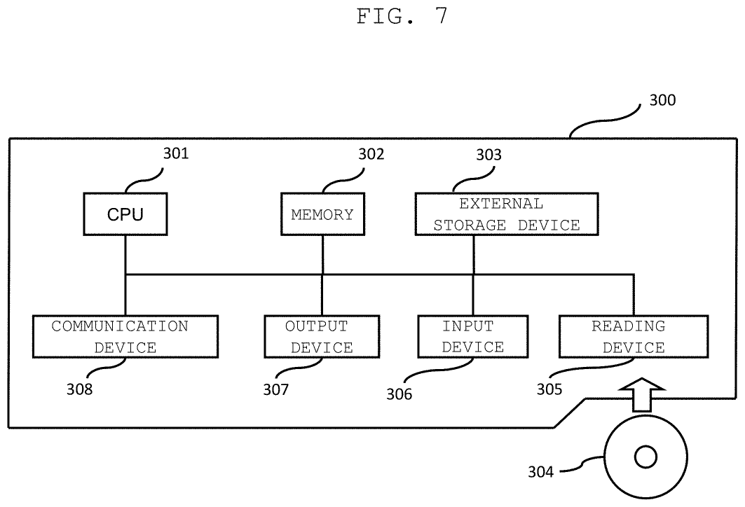

FIG. 7 is a diagram illustrating an example of a hardware configuration of the production planning device. The production planning device 100 can be realized by a general computer 300 including a central processing unit (CPU) 301, a memory 302, an external storage device 303 such as a hard disk drive (HDD), a reading device 305 which reads information from a portable storage medium 304 such as a compact disk (CD) or a digital versatile disk (DVD), an input device 306 such as a keyboard, a mouse, or a bar code reader, an output device 307 such as a display, and a communication device 308 which communicates with another computer via a communication network such as the Internet, or a network system including a plurality of the computers 300. Incidentally, needless to say, the reading device 305 may be capable of not only reading the portable storage medium 304 but also writing.

For example, the data acquisition unit 121, the workload estimation unit 122, the workload aggregation unit 123, the workload leveling unit 124, the violation probability estimation unit 125, the influence degree calculation unit 126, and the display control unit 127 included in the processing unit 120 can be realized by loading a predetermined program stored in the external storage device 303 into the memory 302 and executing the program by the CPU 301. The input/output unit 130 can be realized by the CPU 301 using the input device 306 and the output device 307. The communication unit 140 can be realized by the CPU 301 using the communication device 308. The storage unit 110 can be realized by the CPU 301 using the memory 302 or the external storage device 303.

The predetermined program may be downloaded to the external storage device 303 from the portable storage medium 304 via the reading device 305 or from the network 50 via the communication device 308, and then may be loaded on the memory 302 and executed by the CPU 301. Further, the program may be directly loaded onto the memory 302 from the portable storage medium 304 via the reading device 305 or from the network via the communication device 308 and executed by the CPU 301.

Incidentally, the designing device 200 can also be realized by the general computer 300 as illustrated in FIG. 7.

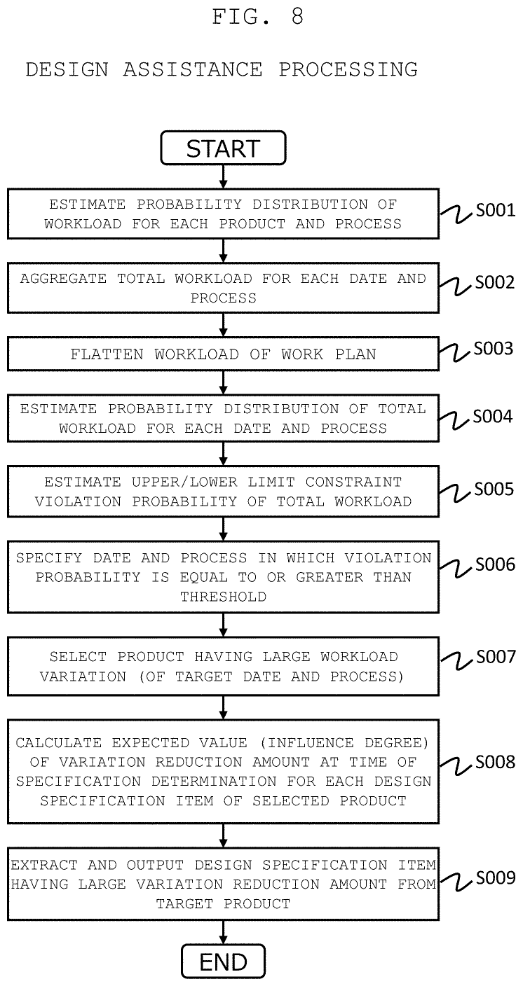

FIG. 8 is a diagram illustrating an example of a flow of design assistance processing. The design assistance processing is started in a case where the production planning device 100 accepts a request after activation, or in accordance with a predetermined cycle (for example, every day).

First, the workload estimation unit 122 estimates the probability distribution of the workload for each product and process (step S001). Then, the workload aggregation unit 123 aggregates the total workload for each date and process (step S002). Specifically, the workload aggregation unit 123 calculates the sum of the workloads of all the products to be produced for each date and process by using the probability distribution of the workload of the product to be produced assigned to each date and process, and aggregates the total workload.

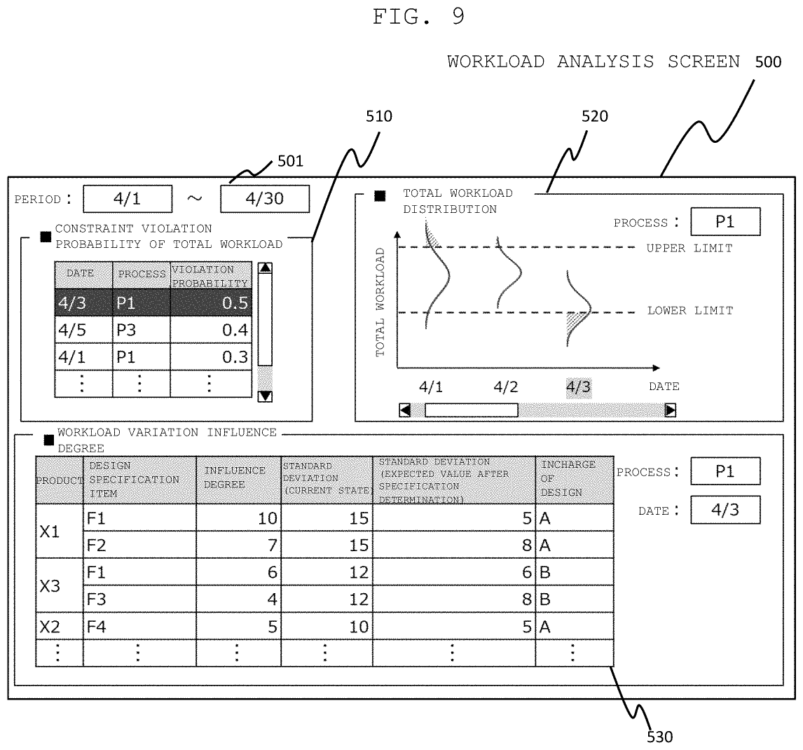

Then, the workload leveling unit 124 levels the workload of the work plan by flattening (step S003). Then, the violation probability estimation unit 125 estimates the probability distribution of the total workload for each date and process (step S004). Specifically, the violation probability estimation unit 125 estimates, for the work plan leveled by the workload leveling unit 124, the probability distribution of the total workload which is the sum of the workloads of all products to be produced according to a design item with determined specifications for each combination of dates and execution processes. Incidentally, this total workload may be output to a display area 520 of the total workload distribution in FIG. 9.

Then, the violation probability estimation unit 125 estimates the upper/lower limit constraint violation probability of the total workload (step S005). Specifically, the violation probability estimation unit 125 estimates a probability (a sum of a probability of exceeding the upper limit value of the work capacity and a probability of falling below the lower limit value of the work capacity) that the total workload exceeds the upper and lower limit values by using the upper and lower limit values of the work capacity of each date and process set as the work capacity information 113 and the total workload. Incidentally, this violation probability may be output to a display area 510 of the constraint violation probability in FIG. 9.

Then, the influence degree calculation unit 126 specifies a date and process in which the violation probability is equal to or greater than the threshold (step S006).

Then, the influence degree calculation unit 126 selects one or more products having a large workload variation (of the target date and process) in descending order of variation (step S007). Incidentally, the influence degree calculation unit 126 performs the processing of this step with the magnitude of the variance or standard deviation of the probability distribution of the workload as the magnitude of the variation.

Then, the influence degree calculation unit 126 calculates, for each design specification item of the selected product, an expected value (influence degree) of the variation reduction amount of the workload at the time of specification determination (step S008). Specifically, the influence degree calculation unit 126 calculates an expected value of the workload variation at the time of determining the selected design specification item, and calculates a difference from the present (before determination) variation to calculate the expected value (influence degree). In the calculation of the expected value, the influence degree calculation unit 126 refers to the design specification master 211, specifies a difference from the load probability distribution in which the selected design specification item is undetermined, and sets the difference as the expected value.

Then, the display control unit 127 extracts a design specification item having a large variation reduction amount from the target product, and outputs a screen showing the design specification item as a design specification item to be preferentially designed (step S009). Incidentally, the design specification item to be designed preferentially may be output to a display area 530 of the workload variation influence degree in FIG. 9.

The above is an example of the flow of the design assistance processing. According to the design assistance processing, it is possible to present the design specification item effective for improving the prediction accuracy of the workload.

FIG. 9 is a diagram illustrating an example of a workload analysis screen. A workload analysis screen 500 is an example of a screen displayed in step S009 of the design assistance processing. The workload analysis screen 500 includes a period input unit 501 which receives designation of a period to be analyzed, the display area 510 of the constraint violation probability of the total workload for each date and process in the period input to the period input unit, the display area 520 of the total workload distribution, and the display area 530 of the workload variation influence degree.

The total workload distribution is a graph of the probability distribution of the sum of the workloads of all products produced by performing the same process on the same date in which the total workload calculated for each date is provided on a vertical axis, and a date is provided on a horizontal axis.

The workload variation influence degree clearly indicates the degree (workload reduction amount) of the influence applied by specification determination for each of all design specification items of all products produced by performing the same process on the same date. The expected value after specification determination clearly indicates the standard deviation after the degree of the influence applied by specification determination is reflected. An incharge of design is information for specifying a person in charge of design of product specifications or an organization in charge of design and is acquired by the display control unit 127 from the ordered product information 111 (not illustrated) and the product-specific design specification information 212 of the designing device 200.

The production planning system according to the first embodiment has been described above. According to this production planning system, it is possible to present the design specification items effective for improving the prediction accuracy of the workload.

Incidentally, the present invention is not limited to the above embodiment and includes various modifications. For example, the upper/lower limit constraint violation probability may be calculated with a changed weighting between the upper limit violation probability and the lower limit violation probability. This is because the violation of the upper limit constraint is fatal since the production plan itself cannot be executed (not achieved) when the violation of the upper limit constraint occurs, but the production itself can be performed (achieved) when the violation of the lower limit constraint occurs. Further, in the above example, the workload is shown with a probability distribution of a normal distribution, but the present invention is not limited thereto, and the workload may be shown with a probability distribution or a probability function of a non-normal distribution.

The design specification items may include items which can be determined in any order and items which cannot be determined in any order, and in this case, it is necessary to consider the order of the design specification items to be determined. For example, the information in which each design specification item is associated with another design specification item prerequisite for the determination may be stored in the storage unit 110, and calculation may be performed such that the design specification item has no degree of influence (the degree of influence is set to zero) unless all prerequisite design specification items are determined. In this way, it is possible to avoid presenting, as the prioritized design item, the design specification item with an undetermined prerequisite design specification item.

There is a more time to spare as the period until the execution date of the production process is longer, and thus considering that there is a situation where the design specification item having a shorter period until the execution date of the production process is necessarily prioritized, for the design specification item in which the period until the execution date of the production process is long, the influence degree calculation unit 126 may calculate the degree of the influence on the probability distribution to be small (for example, the influence degree is increased or decreased according to the period up to the execution date). In this way, the design specification item having a shorter period until the execution date of the production process can be presented preferentially.

A part of the configuration of one embodiment can be replaced with the configuration of another embodiment, and the configuration of another embodiment can be added to the configuration of one embodiment.

It is possible to add, delete, and replace other configurations for a part of the configuration of the embodiment.

Some or all of the above-described configurations, functions, processing units, processing means, and the like may be realized by hardware, for example, by designing with an integrated circuit. Further, each of the above-described configurations, functions, and the like may be realized by software by a processor interpreting and executing a program for realizing each function. Information such as a program, a table, and a file for realizing each function can be stored in a recording device such as a memory, a hard disk, and an SSD, or a recording medium such as an IC card, an SD card, and a DVD.

Control lines and information lines illustrated are those considered necessary for the purpose of description, and do not necessarily correspond to all of the control lines or information lines that are required in a product. In practice, it may be conceivable that most of the configurations are connected to each other by a communication network, a bus, or the like.

The technology according to the present invention is not limited to the production planning system, and can be provided in various modes such as a server device, a computer-readable program, and a production planning method.

### REFERENCE SIGNS LIST

1 Production planning system
50 Network
100 Production planning device
110 Storage unit
111 Ordered product information
112 Process Information
113 Work capacity information
114 Production plan information
115 Total workload distribution information
116 Violation probability information
117 Influence degree information
120 Processing unit
121 Data acquisition unit
122 Workload estimation unit
123 Workload aggregation unit
124 Workload leveling unit
125 Violation probability estimation unit
126 Influence degree calculation unit
127 Display control unit
130 Input/output unit
140 Communication unit
200 Design unit
211 Design specification master
212 product-specific design specification information

What is claimed is:

1. A production planning system comprising:
an influence degree calculation unit that calculates a degree of influence which is applied on a probability distribution of a workload in a predetermined production process of a product by determining an undetermined design specification item of the product; and
a display control unit that causes the design specification item and the degree of influence to be displayed in association with each other.

2. The production planning system comprising:
a violation probability estimation unit that obtains, for a plurality of products to be produced, a total workload which is a sum of workloads of the plurality of products to be produced for each execution date of a predetermined process, and estimates a violation probability which is a probability that the total workload is not included within a predetermined range specified by an upper limit value and a lower limit value of a work amount for executing the process; and
a display control unit that causes the predetermined process, the execution date, and the violation probability to be displayed in association with each other.

3. The production planning system comprising:
a violation probability estimation unit that obtains, for a plurality of products to be produced, a total workload which is a sum of workloads of the plurality of products to be produced for each execution date of a predetermined process, and estimates a violation probability which is a probability that the total workload is not included within a predetermined range specified by an upper limit value and a lower limit value of a work amount for executing the process; and
a display control unit that causes a graph showing a probability distribution of the violation probability of each execution date to be displayed for the predetermined process.

4. The production planning system according to claim 1, further comprising:
a violation probability estimation unit that obtains, for a plurality of products to be produced, a total workload which is a sum of workloads of the plurality of products to be produced for each execution date of a predetermined process, and estimates a violation probability which is a probability that the total workload is not included within a predetermined range specified by an upper limit value and a lower limit value of a work amount for executing the process, wherein
the influence degree calculation unit calculates the influence degree for a product in which a date when the violation probability becomes equal to or greater than a predetermined value is an execution date of the predetermined process, and
the display control unit further causes the predetermined process, the execution date, and the violation probability to be displayed in association with each other.

5. The production planning system according to claim 1, wherein
the display control unit causes the design specification item in which the probability distribution further converges due to the determination of the design specification item to be displayed as a prioritized design item.

6. The production planning system according to claim 4, wherein
the influence degree calculation unit calculates a change amount of the violation probability as the influence degree.

7. The production planning system according to claim 1, wherein
in a case where each design specification item is associated with another design specification item prerequisite for determination, the influence degree calculation unit performs calculation such that there is no influence degree unless all prerequisite design specification items are determined.

8. The production planning system according to claim 1, wherein
the influence degree calculation unit calculates the degree of influence on the probability distribution to be smaller as a period until an execution date of the production process is longer in processing of calculating the degree of influence.
